(19) United States
(12) Patent Application Publication
(10) Pub. No.: US 2010/0037133 A1
(43) Pub. Date: Feb. 11, 2010

(54) DOCUMENT PROCESSING DEVICE, DOCUMENT PROCESSING METHOD, AND COMPUTER READABLE MEDIUM

(75) Inventor: Takanobu Otsubo, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/400,004

(22) Filed: Mar. 9, 2009

(30) Foreign Application Priority Data
Aug. 7, 2008 (JP) 2008-204558

(51) Int. Cl. G06F 17/00

(52) U.S. Cl. 715/273

(57) ABSTRACT

A document processing device includes: a setting unit that sets an acquisition condition of data to be arranged as an additional element in a region on a printing format document in correlation with the region; an acquiring unit that acquires the data according the acquisition condition set by the setting unit; an arranging unit that arranges the data acquired by the acquiring unit as the additional element in the region on the printing format document, correlated with the condition used for acquisition of the data; and a creating unit that creates a printing format document having data of ground with display contents in which display content by the additional element and display content by the ground are unified, by executing virtual printing for data of the additional element arranged on the printing format document by the arranging unit and data of the ground of the printing format document.

### CROSS-REFERENCE TO RELATED APPLICATIONS

This application is based on and claims priority under 35 U.S.C. 119 from Japanese Patent Application No. 2008-204558 filed Aug. 7, 2008.

### BACKGROUND

1. Technical Field

This invention relates to a document processing device, a document processing method, and a computer readable medium.

2. Related Art

Documents created in a medical field as consulting records of patients include document elements in various data formats acquired from various data sources. Specifically, they include a plurality of document elements such as data of an image or graphic (table, graph, etc) created by various checkup devices, data of a series of characters described by a doctor in charge and a doctor in checkup, or data acquired referring other documents or data base.

Meanwhile, the data to be document elements are not necessarily wholly prepared in creating the document, but may be newly generated after the document has been once created as the consulting records (e.g. insertion of checkup data into a progress note or document at the urgent time of the patient).

Traditionally, the document of consulting records was created using a paper medium. The data generated afterward is outputted in another sheet of paper; it was afterward inserted in the document of the consulting record or superposedly put on the document (so that it is folded if extended out, or the ground information can be seen if turned up).

In recent years, an electronic document in a printing format (hereinafter referred to as a printing format electronic document) has been created by executing virtual printing processing using a virtual printer driver (“virtual printer”) on the basis of the information on a recording object. Using the feature of this printing format document that it has the date structure difficult to edit the contents of the document, by creating the consulting record as the printing format document, it might be held as an original document.

### SUMMARY

According to an aspect of the present invention, a document processing device includes: a setting unit that sets an acquisition condition of data to be arranged as an additional element in a region on a printing format document in correlation with the region; an acquiring unit that acquires the data according the acquisition condition set by the setting unit; an arranging unit that arranges the data acquired by the acquiring unit as the additional element in the region on the printing format document, correlated with the condition used for acquisition of the data; and a creating unit that creates a printing format document having data of ground with display contents in which display content by the additional element and display content by the ground are unified, by executing virtual printing for data of the additional element arranged on the printing format document by the arranging unit and data of the ground of the printing format document.

### BRIEF DESCRIPTION OF THE DRAWINGS

Exemplary embodiment of the present invention will be described in detail based on the following figures, wherein:

FIG. 1 is a view illustrating functional blocks of the document processing device according to an embodiment of this invention;

FIG. 2 is a view illustrating a data structure of condition data according to an embodiment of this invention;

FIGS. 3A and 3B are views for explaining the processing by the document processing device according to an embodiment of this invention;

FIGS. 4A and 4B are views for explaining the fixing processing according to an embodiment of this invention;

FIG. 5 is a view showing an example of the flow of the acquisition processing and arrangement processing according to an embodiment; and

FIG. 6 is a view illustrating the hardware configuration of a computer according to an embodiment of this invention.

### DETAILED DESCRIPTION

This invention will be concretely explained on the basis of an embodiment thereof.

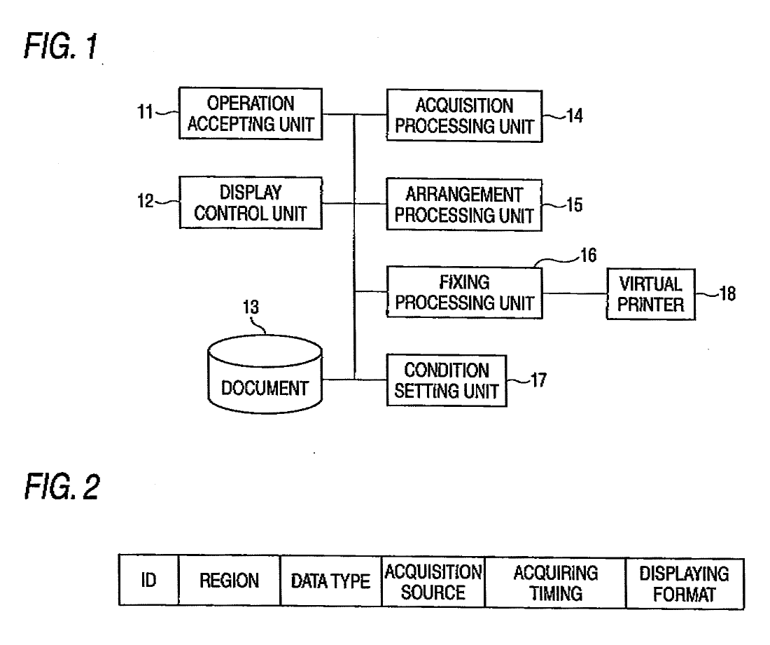

FIG. 1 is a functional block diagram of the document processing device according to an embodiment of this invention.

The document processing device according to this embodiment includes an operation accepting unit 11, a display control unit 12, a document managing unit 13, an acquisition processing unit 14, an arrangement processing unit 15, a fixing processing unit 16, a condition setting unit 17 and a virtual printer unit 18.

The operation accepting unit 11 accepts an operation input in such a manner that an operator operates the device such as a keyboard or mouse provided on the document processing device.

The display control unit 12 controls a display output of various kinds of information for a display screen provided in the document processing device.

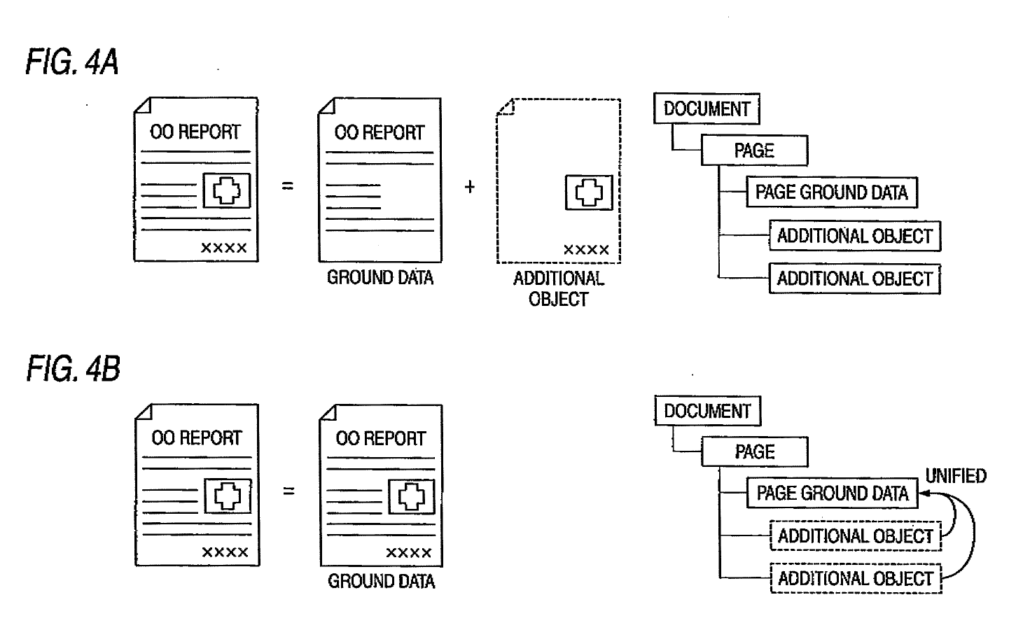

The document managing unit 13 stores and manages the printing format document to be processed by the document processing device. The printing format document to be processed may be various printing format documents such as a PDF (Portable Document Format) document or a DocuWorks (Trademark). As shown in FIG. 4A, it may have a data structure in which an additional object (additional element) can be additionally arranged on the ground (or base) of each of pages in the document. Incidentally, the ground of the printing format document has the data structure difficult to edit the displayed contents. However, by adding the additional object to this data structure, the displayed contents of the printing format document can be apparently changed.

The condition setting unit 16 sets a condition about acquisition of the data to be arranged as the additional object on the pertinent region (hereinafter referred to as an acquisition condition) and condition about the displaying format of the additional object (hereinafter referred to as a displaying condition), these conditions being correlated with the regions on the printing format document. The condition data may be stored as the data integral to the printing format document or separate data.

The condition data in this embodiment, as illustrated in FIG. 2, includes items of “ID”, “region”, “data type”, “acquisition source”, “acquisition timing”, “displaying format”, etc.

“ID” is discriminating information of the condition data.

“Region” is information indicative of the region on the printing format document on which the additional object is arranged (e.g. coordinate value).

“Data type” is information indicative of the type of the data to be arranged as the additional object (text data, image data, graphic data, etc.).

“Acquisition source” and “acquisition timing” are information of the acquisition condition of the data to be arranged as the additional object. “Acquisition source” is information specifying the acquisition source of the data (name, ID or IP address of an acquisition source system/device) or information specifying the data acquired from the acquisition source (in the case of a medical system, name of the patient, ID, checkup type, date, etc.). “Acquisition timing” is information of the date when acquisition of the data is executed.

“Displaying format” is information indicative of the displaying condition of the additional object and has setting items different according to the data type. For example, as regards the text data, items of information of font, color, character size, etc. are set. As regards the image data, items of information of resolution, monochrome/color, image size, etc. are set.

Additionally, in this embodiment, a person in charge of the printing format document to be processed selects a region on the printing format document and sets the above condition data for the region selected. However, other setting technique may be adopted. For example, using the pattern according to uses with the condition data previously set for each of regions on the printing format document, apart of the setting contents of the condition data (e.g. data specifying information of a patient ID) may be edited.

The acquisition processing unit 14 acquires the data according to the condition data set by the condition setting unit 16. Specifically, at the date and time indicated in the item of the “acquisition timing” of the condition data, the system/device indicated in the item of the acquisition source is accessed to acquire the pertinent data. The “acquisition timing” may be not necessarily set. In this case, the data acquisition source may be periodically monitored to acquire the data when they are created. Otherwise, when display of the document is instructed by an operator, the acquisition processing may be executed before the document is displayed or according to an instruction of acquisition.

The arrangement processing unit 15 arranges the data acquired by the acquisition processing unit 14 on the printing format document as the additional object according to the condition data used for its acquisition. Namely, the arrangement processing unit 15 processes the manner of the acquired data according to the “displaying format” of the condition data and superposedly arranges the data resulting from the processing as the additional object on the ground of the printing format document. The arranging position of the additional object is determined according to the setting contents of the “region” of the condition data.

The fixing processing unit 16 executes virtual printing for the data on the ground of the printing format document and the data of the additional object arranged on the ground using the virtual printer unit 18, thereby creating the printing format document having the data on the ground of the display contents where the display contents by the pertinent ground and those by the additional object are unified (hereinafter referred to as the fixing processing).

In this embodiment, the printing format document thus created is substituted for the printing format document as its base (overwrite holding), but it may be added as a new version (another document).

Further, in this embodiment, whenever the data acquired by the acquisition processing unit 14 is arranged on the printing format document as the additional object by the arrangement processing unit 15, the fixing processing is executed for this additional object newly arranged. However, after the additional objects are arranged on all the regions set for the pertinent printing format document, the fixing processing may be done for all the additional objects. Otherwise, when display of the document is instructed by an operator, before the document is displayed or according to an instruction of fixing, the fixing processing may be executed for the additional object arranged at the timing of the instruction of fixing.

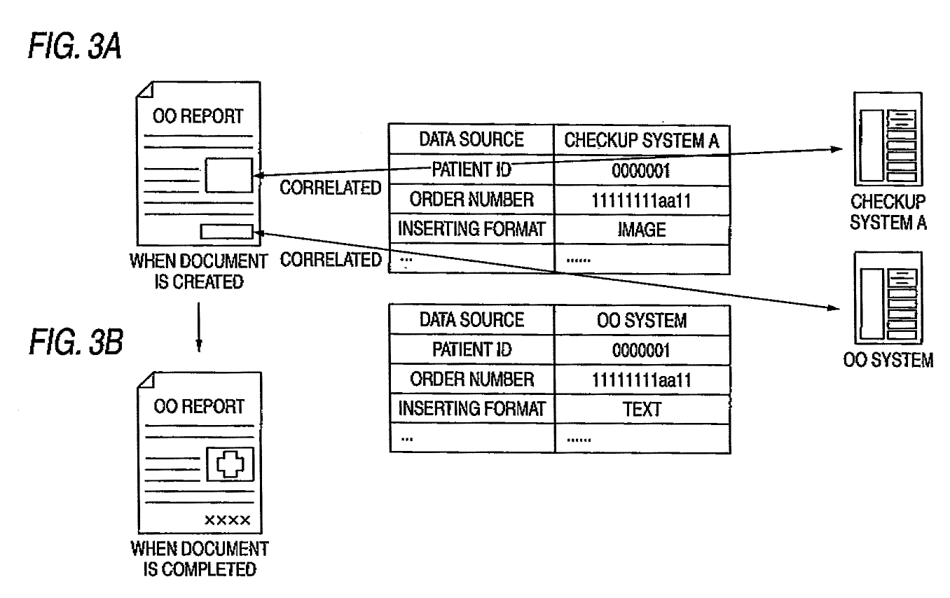

FIG. 3A illustrates a printing format document at an initial timing (not-completed state). Regions of blank columns are provided on the middle stage and lower stage of the document. The condition data are set for the respective regions. As for the condition data for the region at the middle stage, a “testing system A” is set as the data source indicative of the information specifying the acquisition source and an “image” is set as the inserting format indicative of the data type. As for the condition data for the region at the lower stage, a “oo system” is set as the data source indicative of the information specifying the acquisition source and an “text” is set as the “inserting format” indicative of the data type. Incidentally, as for the “patient ID” and “order number” indicative of the information specifying the data, the same values are set in the regions at the middle stage and lower stage.

According to these condition data, the pertinent data are acquired by the acquisition processing unit 14 and are arranged on the printing format document as the additional objects by the arrangement processing unit 15, thereby providing the displaying contents as shown in FIG. 3B. Thereafter, by executing the fixing processing, the document is completed.

FIGS. 4A and 4B illustrate the data structure of the printing format document before and after the fixing processing.

Before the fixing processing, as shown in FIG. 4A, a certain page within the printing format document consists of ground data and two additional objects. After the fixing processing, as shown in FIG. 4A, both additional objects are unified with the ground data. Incidentally, the displaying contents of the printing format document remain unchanged before and after the fixing processing.

Next, an explanation will be given of the processing flow of data acquisition and arrangement.

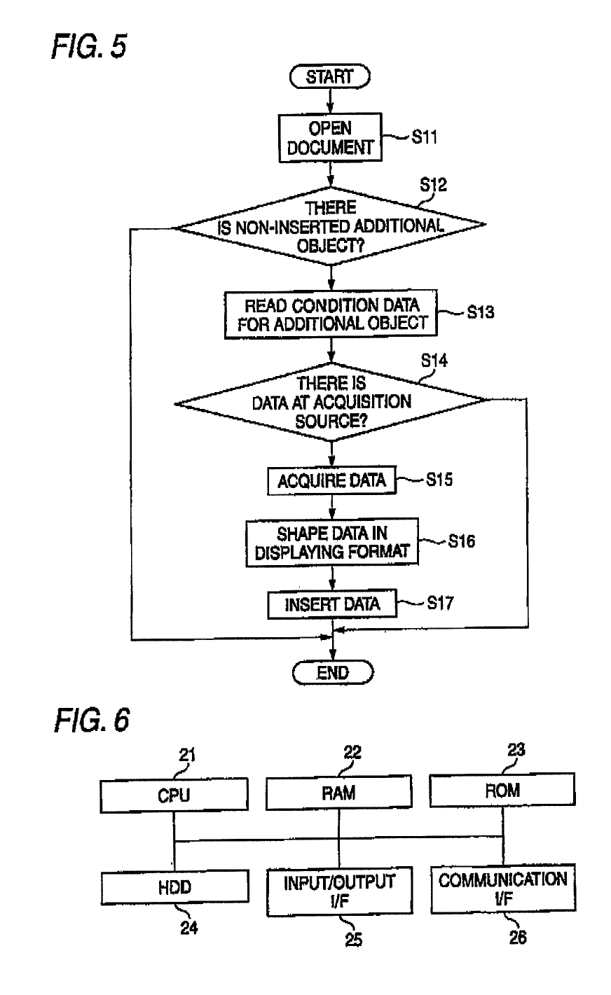

In this embodiment, referring to an example of the flow shown in FIG. 5, the explanation will be given of the case where when display of the document is instructed, the data acquisition and arrangement are executed before the document is displayed.

When an instruction of opening a document (printing format document) (an instruction of displaying the contents thereof) is issued by the operator (step S11), it is determined if or not there is any non-inserted additional object for the document to be processed (for which the data acquisition and arrangement have not been yet done) (step S12).

If it is determined that there is the non-inserted additional object, the condition data for this non-inserted additional object is read (step S13). Further, it is determined if or not there is the corresponding data at the acquisition source on the basis of an acquisition condition set for the condition data (step S14). If it is determined that there is the pertinent data, the data is acquired (step S15). The data thus acquired is shaped (or worked) according to the displaying condition set for the condition data (step S16). The data thus shaped is arranged on the pertinent region of the document as the additional object and subjected to the fixing processing (step S17). The resultant document is opened and its contents are displayed on a display screen. If it is determined in step S12 that there is no non-inserted additional object, or determined in step S14 that there is no pertinent data at the acquisition source, without executing the processing such as the data acquisition, the document to be processed is opened and its contents are displayed on the display screen.

Next, an explanation will be given of an extensive example of the document processing device according to this example.

For example, if the timing of executing the processing of arrangement and fixing of the additional object differs, there is possibility of editing the additional object. As a countermeasure therefor, an attribute value of prohibition of edition is applied to the additional object arranged thereby preventing the contents of the additional object from being edited. Otherwise, using a secret key peculiar to the document processing device, an electronic signature is applied to the additional object thereby making it detectable if or not the contents of the additional object has been edited.

For example, there is provided a means which if the processing of data acquisition and arrangement is not done within a predetermined period of time, reports this fact to the person in charge of creating the document (e.g. transmission of an electronic mail).

For example, there is provided a means which if the data are arranged in all the set regions and fixed (i.e. the document is completed), reports this fact to the person in charge of creating the document (e.g. transmission of an electronic mail).

For example, there is a provided a means which explicitly displays the processing contents (preset contents of the condition data) of for a non-processed region (e.g. displaying the processing contents within the pertinent region in the form of a table) so that the completed form of the document can be known to some extent.

FIG. 6 shows main hardware of the computer constituting the document processing device according to this embodiment.

The hardware according to this embodiment is the computer having hardware resources inclusive of a CPU (Central Processing Unit) 21 executing various kinds of arithmetic operations; a RAM (Random Access Memory) 22 providing a working region of the CPU 21; a ROM (Read Only Memory) 23 storing a basic control program; an HDD (Hard Disc Drive) 24 storing a program for realizing the function relative to an embodiment of this invention and various data; an input/output I/F 25 which is an interface with a display of displaying/outputting the information for the operator and the device such as a mouse and keyboard for accepting an input of the information from the operator; and a communication I/F 26 which is an interface executing communication with other devices.

The program for realizing the function relative to an embodiment of this invention is read out from the HDD 24 and developed onto the RAM 22. This program is executed by the CPU 21. Thus, the respective functional means according to an embodiment of this invention are realized by the computer.

In this embodiment, the condition setting unit 17 realizes the setting means according to this invention; the acquisition processing unit 14 realizes the acquiring means according to this invention; the arrangement processing unit 15 realizes the arranging means according to this invention; and the fixing processing 16 and virtual printer unit 18 realize the creating means according to this invention.

Further, in this embodiment, the respective functional units are provided in a single device, but they may be provided to be scattered in a plurality of device.

Further, the respective functional units should not be limited to the manner of being realized by software like this embodiment, but maybe realized by corresponding dedicated hardware modules.

Further, the program according to this invention can be supplied to the user of the program relative to this invention in a manner of distributing an external storage medium such as CD-ROM storing the pertinent program or manner of distributing the program through a communication network.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A document processing device comprising:
a setting unit that sets an acquisition condition of data to be arranged as an additional element in a region on a printing format document in correlation with the region;
an acquiring unit that acquires the data according the acquisition condition set by the setting unit;
an arranging unit that arranges the data acquired by the acquiring unit as the additional element in the region on the printing format document, correlated with the condition used for acquisition of the data; and
a creating unit that creates a printing format document having data of ground with display contents in which display content by the additional element and display content by the ground are unified, by executing virtual printing for data of the additional element arranged on the printing format document by the arranging unit and data of the ground of the printing format document.

2. The document processing device as claimed in claim 1,
wherein
the creating unit, in a case where conditions of data acquisition are set in correlation with a plurality of regions on the printing format document, respectively, whenever the data acquired by the acquiring unit is arranged as the additional element by the arranging unit, executes virtual printing for the data of an additional element newly arranged and the data of the ground of the printing format document.

3. The document processing device as claimed in claim 1,
wherein
the setting unit sets the condition on a displaying format of the additional element in correlation with the region on the printing format document, and
the arranging unit arranges the data acquired by the acquiring unit on the corresponding region of the printing format document in a manner according to the condition on the displaying format of the additional element.

4. A document processing method comprising:
setting an acquisition condition of data to be arranged as an additional element in a region on a printing format document in correlation with the region;
acquiring the data according the acquisition condition set in the setting step;
arranging the data acquired in the acquiring step as the additional element in the region on the printing format document, correlated with the condition used for acquisition of the data; and
creating a printing format document having data of ground with display contents in which display content by the additional element and display content by the ground are unified, by executing virtual printing for data of the additional element arranged on the printing format document in the arranging step and data of the ground of the printing format document.

5. A computer readable medium storing a program causing a computer to execute a process for performing document processing, the process comprising:
setting an acquisition condition of data to be arranged as an additional element in a region on a printing format document in correlation with the region;
acquiring the data according the acquisition condition set in the setting step;
arranging the data acquired in the acquiring step as the additional element in the region on the printing format document, correlated with the condition used for acquisition of the data; and
creating a printing format document having data of ground with display contents in which display content by the additional element and display content by the ground are unified, by executing virtual printing for data of the additional element arranged on the printing format document in the arranging step and data of the ground of the printing format document.
